(19) United States
(12) Patent Application Publication
(10) Pub. No.: US 2009/0008943 A1
(43) Pub. Date: Jan. 8, 2009

(54) Residential hydroelectric generator

(76) Inventor: John Joseph Kemper, Temecula, CA (US)

Correspondence Address: John Joseph Kemper, 45719 HAWK COURT, Temecula, CA, 92592, US

(21) Appl. No.: 11/825,402

(22) Filed: Jul. 5, 2007

(51) Int. Cl. F03B 13/00

(52) U.S. Cl. 290/54

(57) ABSTRACT

In this age of global warming, solar cells, and wind power, this invention utilizes incoming utility water pressure to generate electricity. Each time the faucet is turned on, the grass is watered, and even when the toilet is flushed, electricity will be generated. The idea of hydroelectric power generated in the home, multi-family or commercial use is the basis for this invention.

### BACKGROUND OF THE INVENTION

Every home has an untapped energy source: incoming water pressure. This invention will utilize this energy source to generate electricity for; usage, battery storage, or sale back to the electric utility company by tapping into the incoming water pressure and using it to generate electricity. This may cause some reduction in internal residential or commercial water pressure, but not enough to effect performance. This product is similar in concept to solar and wind power, and will complement these products.

### BRIEF SUMMARY OF THE INVENTION

The two major components of this product have already been invented. What makes this idea unique is that these two components have never been used together, and, in the context of utility water. The two major components are a water pump and an electrical generator. This patent only excludes the use of these two products together and only in the context of home, multi-family, or commercial electricity generation by using utility water pressure. It may also be necessary to use this product in conjunction with other alternative energy conversion systems such as: power inverters, storage batteries, and electrical components that allow the transfer of power backward from the generation source to the utility company. These other electricity conversion systems are not addressed or claimed in this patent.

### DETAILED DESCRIPTION OF THE INVENTION

The two main components of this invention are:
1.) The water pump: a water pump has internal fins or blades which turn as water flows through it. A water pump can be used to circulate water, but in this case, will be used along an existing incoming water line to cause an external motion similar to a wind mill, but in water. The water pump has been around for many years and is not claimed here.
2.) The generator: this device, sometimes called an alternator or a generator, generates electricity from the turning of an actuator in relationship to the coil windings. This item has also been around for many years and is not claimed in this patent.

By connecting the generator to the turning axle of the water pump as illustrated, and considering the fact that the average American uses literally hundreds of gallons of water daily, this incoming water can be used to generate electricity, but only when the water is flowing.

Ideally, this product will use a pipe diameter equivalent to the incoming residential water line diameter, but may have a water pump and generator of varying sizes with two outgoing power lines for connection to the home electrical system. The ideal size would be equivalent to the size of two residential water meters strapped together.

### BRIEF DESCRIPTION OF THE DRAWINGS

A description of the figures (FIG) are as follows:

FIG. 1—Top View with see through to inner assemblies.

FIG. 2—Side View with see through to inner assemblies.

FIG. 3—Angular View with see through to inner assemblies.

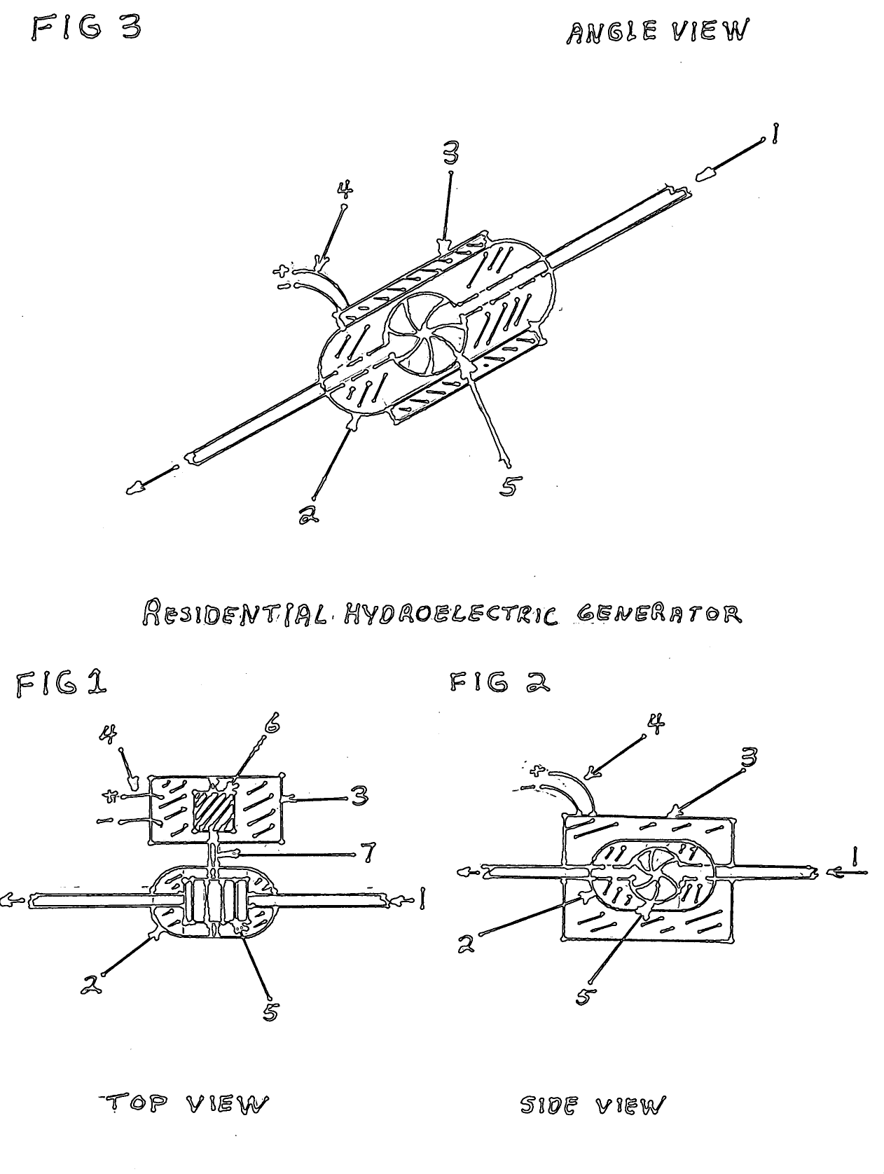

Within each of the figures, the numbered parts are as follows: Number 1—the incoming water and pipe. Number 2—the water pump body. Number 3—the generator body. Number 4—the external power leads. Number 5—the water pump drive mechanism. Number 6—the generator actuator. Number 7—the axle connecting the water drive pump to the generator.

I claim:

1. The use of incoming residential/commercial utility water for hydroelectric electricity generation.

2. The idea of combining two previously existing components, a water pump and a generator, into a power source to be used exclusively in the context of utility water at the residential or commercial level.

3. All feasible variations in designs & sizes of water pumps, generators, and inflow water pipes exclusively for residential/commercial use in hydroelectric electricity generation.
